(19) United States
(12) Patent Application Publication
(10) Pub. No.: US 2026/0223953 A1
(43) Pub. Date: Aug. 6, 2026

(54) AEROSOL-GENERATING APPARATUS AND CONTROL METHOD THEREFOR

(71) Applicant: SHENZHEN FIRST UNION TECHNOLOGY CO., LTD., Shenzhen, Guangdong (CN)

(72) Inventors: Guangping CAO, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/159,142

(22) PCT Filed: Feb. 24, 2023
(86) PCT No.: PCT/CN2023/078162

§ 371 Date: Aug. 22, 2025

(51) Int. Cl. A24F 40/57; H05B 1/02

(52) U.S. Cl. CPC A24F 40/57; H05B 1/0202; H05B 1/0252

(57) ABSTRACT

An aerosol-generating apparatus and a control method therefor. According to the method. energy supplied by a power source to a heater is controlled so that a temperature of the heater fluctuates between a first temperature and a second temperature within a desired temperature range within a preset duration. The first temperature is greater than the second temperature. A temperature fluctuation frequency of the heater is substantially constant or varied within the preset duration. By controlling the temperature of the heater to fluctuate between the first temperature and the second temperature within the desired temperature range within the preset duration, and controlling the temperature fluctuation frequency of the heater, aerosols with consistent characteristics can be generated in an inhalation stage.

### TECHNICAL FIELD

This application relates to the technical field of cigarette devices, and in particular, to an aerosol-generating apparatus and a control method therefor.

### BACKGROUND

During use of articles such as cigarettes or cigars, tobacco is burnt to produce tobacco smoke. Attempts have been made to provide alternatives to these tobacco-burning articles by making products that release compounds without combustion. An example of such products is a heat-not-burn product, also referred to as a tobacco heating product, or a tobacco heating device, or an aerosol-generating apparatus, which releases compounds by heating a material without burning it. The material may be, for example, tobacco or other non-tobacco products or combinations, such as a blended mixture that may or may not contain nicotine.

During preheating in an existing aerosol-generating apparatus, after a temperature of a heater rises to a preset temperature, the apparatus may be maintained at the preset temperature for a period of time, usually within 20 s. Then, an inhalation stage is entered, and the preset temperature is maintained for a particular period of time, that is, a preset duration. Within the preset duration, the temperature is controlled to be close to the preset temperature, and the temperature curve is presented as a straight line or an irregular curve within a time slice of seconds. The apparatus using such a control manner has a problem of being incapable of generating aerosols with consistent characteristics in the inhalation stage, degrading usage experience of users.

### SUMMARY

This application provides an aerosol-generating apparatus and a control method therefor, aiming to resolve a problem that the existing aerosol-generating apparatus cannot generate aerosol with consistent characteristics in an inhalation stage.

According to one aspect of embodiments of this application, a control method for an aerosol-generating apparatus is provided, where the aerosol-generating apparatus includes a heater configured to heat an aerosol-forming substrate to generate an aerosol and a power source that provides energy to the heat; where the method includes:
controlling the energy supplied by the power source to the heater, so that a temperature of the heater fluctuates between a first temperature and a second temperature within a desired temperature range within a preset duration, the first temperature being greater than the second temperature;

In an example, a temperature fluctuation frequency of the heater is substantially constant within the preset duration.

In an example, a temperature fluctuation frequency of the heater is substantially constant in a range of 0.05 Hz and 1 Hz. For example, the frequency may be 0.05 Hz, 0.1 Hz, 0.2 Hz, 0.4 Hz, 0.5 Hz, 0.8 Hz, or 1 Hz.

In an example, a temperature fluctuation frequency of the heater is varied within the preset duration.

In an example, a temperature fluctuation frequency of the heater is varied in a range of 0.05 Hz to 1 Hz.

In an example, a temperature fluctuation frequency of the heater gradually changes with time in stages.

In an example, a temperature fluctuation frequency of the heater progressively increases or progressively decreases with time in stages.

In an example, the preset duration includes a plurality of time stages, and a temperature fluctuation frequency of the heater is maintained substantially constant in each of the time stages.

In an example, the preset duration includes a first time stage and a second time stage, and a frequency at which the temperature of the heater fluctuates in the second time stage is greater than a frequency at which the temperature of the heater fluctuates in the first time stage.

In an example, the preset duration includes a first time stage and a second time stage, and a desired temperature range of the heater in the second time stage is different from a desired temperature range of the heater in the first time stage. Specifically, a minimum value of the desired temperature range in the second time stage is greater than a maximum value of the desired temperature range in the first time stage.

In an example, the preset duration includes a plurality of time stages, and a duration of each of the time stages is different.

In an example, the preset duration includes at least two time stages with a same duration.

In an example, when no change indication is obtained, a temperature fluctuation frequency of the heater is changed according to a preset temperature fluctuation frequency and a duration corresponding to the preset temperature fluctuation frequency.

In an example, a temperature fluctuation frequency of the heater is changed when a change indication is obtained.

In an example, the change indication is based on detection of user inhalation.

In an example, a temperature fluctuation frequency of the heater is determined jointly by an amount of energy supplied to the heater and a temperature drop capability of the heater when no energy is provided.

In an example, the aerosol-generating apparatus further includes a voltage regulation circuit; and
the method further includes:
controlling the voltage regulation circuit to control power supplied by the power source to the heater.

In an example, the aerosol-generating apparatus further includes a switch circuit; and
the method further includes:
controlling a turn-on time of the switch circuit to control a supply time of power supplied by the power source to the heater.

In an example, at an initial moment of the preset duration, the turn-on time of the switch circuit is controlled to be a preset reference time.

In an example, the preset reference time is in a range of 1 s to 20 s.

In an example, the initial moment of the preset duration is a moment at which the temperature of the heater reaches a preset temperature or is an end moment when the heater remains at the preset temperature for a period of time; and a terminal moment of the preset duration is an inhalation end moment.

In an example, a difference between the first temperature and the second temperature is in a range of 2° C. and 10° C.

In an example, the method further includes: intermittently detecting a real-time temperature of the heater and controlling the temperature fluctuation of the heater according to the real-time temperature of the heater.

According to another aspect of embodiments of this application, an aerosol-generating apparatus is provided, including:
a heater, configured to heat an aerosol-forming substrate to generate an aerosol;
a power source, supplying energy to the heater; and
a controller, configured to control the energy supplied by the power source to the heater, so that a temperature of the heater fluctuates between a first temperature and a second temperature within a desired temperature range within a preset duration, the first temperature being greater than the second temperature.

In an example, a temperature fluctuation frequency of the heater is substantially constant within the preset duration.

In an example, a temperature fluctuation frequency of the heater is varied within the preset duration.

According to the aerosol-generating apparatus and the control method therefor that are provided in the embodiments of this application, the temperature of the heater is controlled to fluctuate between the first temperature and the second temperature within the desired temperature range within the preset duration, and the temperature fluctuation frequency of the heater is substantially constant or varied within the preset duration, so that aerosols with consistent characteristics can be generated in an inhalation stage, thereby improving inhalation experience of users.

### BRIEF DESCRIPTION OF THE DRAWINGS

One or more embodiments are exemplified by using corresponding figures in the accompanying drawings, and these exemplified descriptions do not constitute a limitation on the embodiments. Elements with the same reference numerals in the accompanying drawings are denoted as similar elements, and the figures in the accompanying drawings are not limited by scale, unless otherwise particularly stated.

FIG. 1 is a schematic diagram of an aerosol-generating apparatus according to an implementation of this application;

FIG. 2 is a schematic diagram of a voltage regulation circuit according to an implementation of this application;

FIG. 3 is a schematic diagram of a temperature curve of a heater according to an implementation of this application;

FIG. 4 is a schematic diagram of an input waveform of a switch circuit according to an implementation of this application;

FIG. 5 is a schematic change diagram of a temperature fluctuation frequency according to an implementation of this application;

FIG. 6 is another schematic change diagram of a temperature fluctuation frequency according to an implementation of this application;

FIG. 7 is a schematic diagram of another aerosol-generating apparatus according to an implementation of this application; and

FIG. 8 is a schematic diagram of a switch circuit according to an implementation of this application.

### DETAILED DESCRIPTION

To facilitate the understanding of this application, this application is described in more detail below with reference to the accompanying drawings and specific implementations. It should be noted that, when an element is expressed as “being fixed to” another element, the element may be directly on the another element, or one or more intermediate elements may exist between the element and the another element. When one element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are used for illustrative purposes only.

Unless otherwise defined, meanings of all technical and scientific terms used in this specification are the same as those usually understood by a person skilled in the technical field to which this application belongs. The terms in this specification of this application herein are used only for the purpose of describing the specific implementations, but are not intended to limit this application. A term “and/or” used in this specification includes any or all combinations of one or more related listed items.

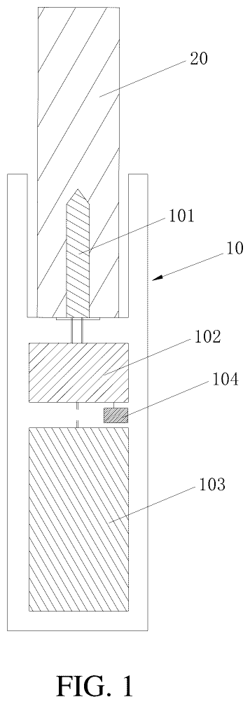

FIG. 1 is a schematic diagram of an aerosol-generating apparatus according to an implementation of this application.

As shown in FIG. 1, an aerosol-generating apparatus 10 includes a heater 101, a controller 102, and a battery cell 103.

The heater 101 is configured to generate heat according to electric power supplied by the battery cell 103, to heat a product 20 placed in the aerosol-generating apparatus 10, so that an aerosol-forming substrate in the product 20 generates an aerosol for inhalation by a user.

In the example in FIG. 1, the heater 101 is configured as a central heating structure (a periphery of the heater is in direct contact with the aerosol-forming substrate), and the heating manner may be resistance heating, infrared radiation heating, electromagnetic heating, or the like.

The controller 102 is separately connected to the heater 101 and the battery cell 103, and is configured to control the electric power that is supplied by the battery cell 103 to the heater 101, to control a heating temperature of the heater 101, so as to heat the aerosol-forming substrate to generate an aerosol.

The controller 102 is further configured to perform a control method for the aerosol-generating apparatus 10.

The aerosol-generating apparatus 10 may further include a storage medium for storing a program for performing the control method for the aerosol-generating apparatus 10, and the controller 102 may read and execute the program, stored in the storage medium, for performing the control method for the aerosol-generating apparatus 10, to implement the control method for the aerosol-generating apparatus 10. The storage medium may be an independent storage device disposed in the aerosol-generating apparatus 10, or may be a storage medium built in the controller 102. The storage medium includes, but is not limited to, a non-volatile storage medium.

The battery cell 103, that is, a power source, is configured to supply electric power to the heater 101 and the controller 102. Under control of the controller 102, the electric power supplied by the battery cell 103 to the heater 101 may be adjusted, to change a temperature of the heater 101. The battery cell 103 may be a rechargeable battery cell or a non-rechargeable battery cell.

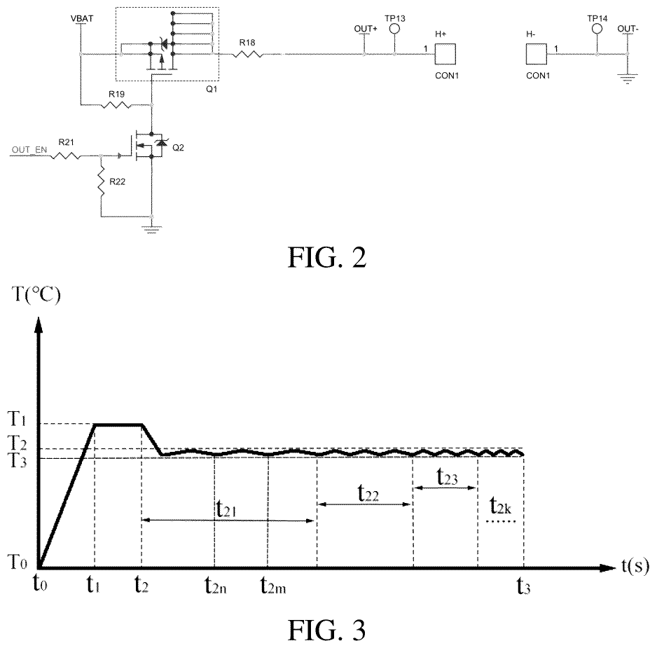

In the example in FIG. 1, the aerosol-generating apparatus 10 further includes a switch circuit 104 coupled between the heater 101 and the battery cell 103. As shown in FIG. 2, the switch circuit 104 includes a switch transistor Q2 and a switch transistor Q1. The switch transistor Q2 and the switch transistor Q1 each include an input connection terminal, an output connection terminal, and a control terminal. In this example, the switch transistor Q2 is an NMOS transistor, and the switch transistor Q1 is a PMOS transistor. In the switch transistor Q2, the input connection terminal is a drain, the output connection terminal is a source, and the control terminal is a gate. In the switch transistor Q1, the input connection terminal is a source, the output connection terminal is a drain, and the control terminal is a gate. The control terminal of the switch transistor Q2 is configured to receive control of the controller 102, to switch on or switch off an electrical connection between the battery cell 103 and the heater 101. The input connection terminal of the switch transistor Q2 is electrically connected to the control terminal of the switch transistor Q1, and the output connection terminal of the switch transistor Q2 is grounded. The input connection terminal of the switch transistor Q1 is electrically connected to the battery cell, and the output connection terminal of the switch transistor Q1 is electrically connected to the heater 101.

In a schematic diagram of a temperature curve of a heater shown in FIG. 3, a horizontal coordinate t of the temperature curve represents time, and a longitudinal coordinate T represents temperature.

At a t0 moment, an initial temperature of the heater 101 is T0. The initial temperature T0 may be an ambient temperature or greater than the ambient temperature.

For a time period from t0 to t1, the controller 102 controls the electric power of the heater 101 to heat at a maximum power or another preset power. For example, the maximum power is 36 W. At a t1 moment, the heater 101 heats to a preset temperature T1.

The preset temperature T1 may be an optimal temperature at which the aerosol-forming substrate generates an aerosol. In other words, the aerosol-forming substrate may provide, at the temperature, a smoke volume and temperature most suitable for a user to inhale and experience a pleasant taste. The preset temperature T1 used in this implementation of this application is in a range of 150° C. to 350° C.; or 180° C. to 350° C.; or 220° C. to 350° C.; or 220° C. to 300° C.; or 220° C. to 280° C.; or 220° C. to 260° C.

For a time period from t1 to t2, the controller 102 controls the electric power supplied by the battery cell 103 to the heater 101, and controls the heater 101 to remain at the preset temperature T1 for a period of time (that is, the time period from t1 to t2). It should be noted that, in other examples, it is also feasible not to set the time period from t1 to t2.

At a t2 moment, the controller 102 may output a prompt signal for aerosol inhalation, to prompt the user to inhale the aerosol. Specifically, a prompt operation may be performed, by using a prompt apparatus connected to the controller 102, according to the prompt signal output by the controller 102. For example, the prompt apparatus is a vibration motor, which vibrates to prompt a user that the aerosol can be inhaled. Alternatively, the prompt apparatus is an LED light, which is steady on or flashes to prompt a user that the aerosol can be inhaled.

For a time period from t2 to t3, after outputting the prompt signal for aerosol inhalation, the controller 102 controls the electric power supplied by the battery cell 103 to the heater 101. Specifically, energy supplied by the battery cell 103 to the heater 101 is controlled, to control a temperature of the heater 101 to be in a desired temperature range, for example, in a range from a desired temperature T3 to a desired temperature T2 shown in the figure. For example, a difference between T3 and T2 is in a range of 2° C. to 10° C.

In this example, the following relationship exists between energy Q supplied to the heater 101, power P supplied to the heater 101, and a supply time t for the power: Q=P*t. The controller 102 may control a turn-on time of the switch circuit 104, to control the energy supplied by the battery cell 103 to the heater 101, that is, control a supply time for power supplied by the power source to the heater 101.

Generally, the desired temperature T2 and the desired temperature T3 are both less than the preset temperature T1. A value of the time period from t2 to t3 may be 120 seconds to 360 seconds or a duration for which inhalation is performed six to 20 times, and the t3 moment is an inhalation end moment.

It may be learned from the figure that, within the time period from t2 to t3, the temperature of the heater 101 fluctuates with time. A frequency at which the temperature fluctuates with time may be, for example, varied in a range of 0.05 Hz to 1 Hz. A temperature fluctuation frequency may also be represented by using a cycle. For example, a time period from t2n to t2m shown in FIG. 3 is a fluctuation cycle, and a reciprocal of this time period is a temperature fluctuation frequency. It may be understood that although a change of dropping from the temperature T1 to the temperature T3 has been shown in the figure, the preheat temperature may also be set to T2. Therefore, the temperature after preheating is completed will reach T2, the preset duration starts, and the temperature fluctuates from T2 to T3 and then rises to T3, thereby forming a temperature fluctuation cycle.

Although not shown in the figure, in the time period from t2 to t3, the temperature fluctuation frequency may also be substantially maintained constant. The temperature fluctuation frequency may be, for example, a frequency in a range of 0.05 Hz to 1 Hz.

The temperature fluctuation frequency is crucial for obtaining good inhalation experience. If the frequency is higher than 1 Hz, the aerosol-generating apparatus may generate noise due to vibration. In addition, within the desired temperature range, the frequency higher than 1 Hz causes excessive energy supply, reduces temperature fluctuations, adversely affects taste, and causes energy waste. When the frequency is lower than 0.05 Hz, insufficient energy supply is caused, reducing TPM of the aerosol and worsening the taste.

In a specific implementation, the controller 102 may obtain a real-time temperature of the heater 101, and control, according to the real-time temperature, the temperature of the heater 101 to fluctuate with time.

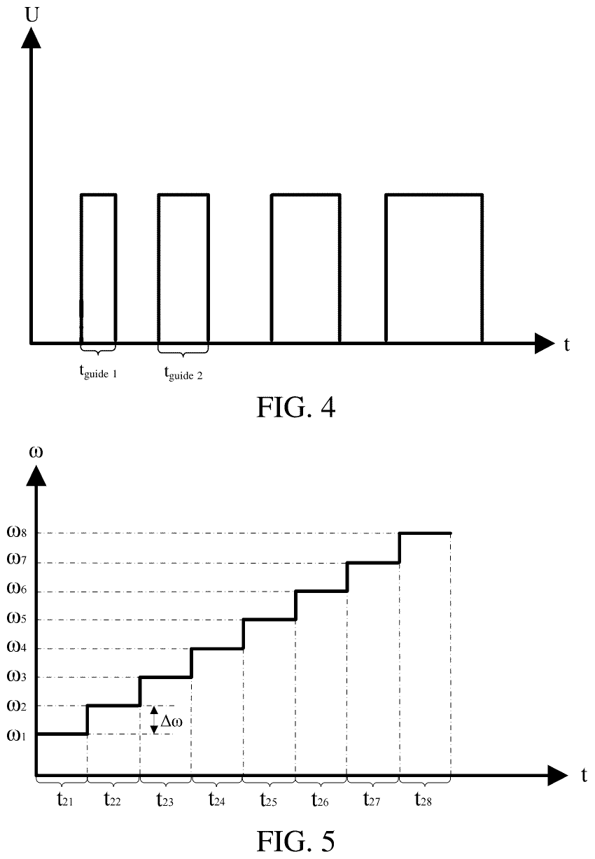

The real-time temperature of the heater 101 may be detected by using a temperature sensor (not shown in the figure) connected to the controller 102, and further may be detected intermittently. The temperature sensor includes, but is not limited to, a thermocouple and a temperature detection module with a resistance temperature coefficient. In a preferred implementation, the heater 101 may have a resistance temperature coefficient, and the real-time temperature of the heater 101 may be determined by using a resistance value of the heater 101. When the real-time temperature of the heater 101 is close to the desired temperature T2, the controller 102 may control the switch circuit 104 to be turned off, that is, no energy is supplied to the heater 101, so that the temperature of the heater 101 naturally drops. When the real-time temperature of the heater 101 is close to the desired temperature T3, the controller 102 may control the switch circuit 104 to be turned on, that is, energy is supplied to the heater 101, so that the temperature of the heater 101 rises. As an example, for a waveform output to the switch circuit 104, reference may be made to FIG. 4. t_{guide 1} and t_{guide 2} in the figure are each a turn-on time controlled by the controller 102 for the switch circuit 104. In this way, the temperature of the heater 101 fluctuates up and down with time. A waveform of the fluctuation is similar to a sine wave or a triangle wave, and an amplitude of the fluctuation (the difference between T2 and T3) is in a range of 2° C. to 10° C., for example, 10° C., 8° C., 6° C., or 4° C.

The time period from t2 to t3 in the figure may be divided into a plurality of time stages t21, t22, t23, . . . , and t2k. Generally, a value of k is determined by the number of times of inhalation by the user. In different time stages (t21 to t2k), temperature fluctuation frequencies may be constant, or may be different, that is, vary with time.

In a preferred implementation, the temperature fluctuation frequency gradually changes with time in stages. For example, the temperature fluctuation frequency progressively increases or progressively decreases with time in stages.

Using FIG. 5 as an example, the time period from t2 to t3 may be divided into eight time stages t21, t22, t23, . . . , and t28. In the first time stage t21, the temperature fluctuation frequency is maintained to be ω1; in the second time stage t22, the temperature fluctuation frequency is maintained to be ω2 ; . . . ; and in the eighth time stage t22, the temperature fluctuation frequency is maintained to be ω8; where ω1 <ω2 <, . . . , <ω8, so that the temperature fluctuation frequency ω progressively increases with time in stages.

In this example, in the eight time stages, the duration of each time stage may be the same or partially the same, or may be different.

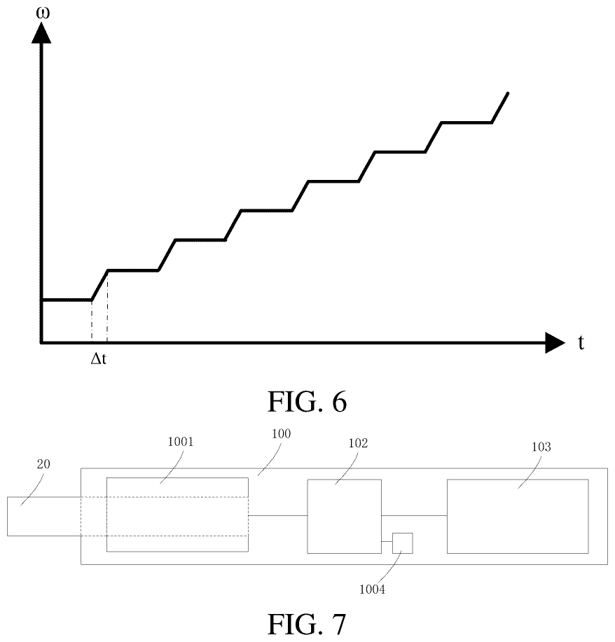

In this example, the change in the temperature fluctuation frequency between adjacent time stages is completed rapidly. In another example, as shown in FIG. 6, the change in the temperature fluctuation frequency may be completed after an interval of At.

In a preferred implementation, the temperature fluctuation frequency may be changed according to a change indication. For example, at a terminal moment of the time stage t21, if user inhalation is detected, the temperature fluctuation frequency is changed from ω1 to ω2.

In a preferred implementation, when no change indication is obtained, the temperature fluctuation frequency of the heater may be changed according to a preset temperature fluctuation frequency and a duration corresponding to the preset temperature fluctuation frequency. For example, in the time stage t22, the temperature fluctuation frequency of the heater is maintained to be ω2. If still no user inhalation is detected at a terminal moment of the time stage t22, the temperature fluctuation frequency of the heater is automatically changed from ω2 to ω3.

It should be noted that, The temperature fluctuation frequency ω is determined jointly by an amount of energy supplied to the heater 101 and a temperature drop capability of the heater 101 when no energy is supplied. Using the time stage t2k as an example, in this stage, the temperature fluctuation frequency is maintained to be ωk. It is assumed that the temperature drop capability of the heater 101 is given when no energy is supplied. When the controller 102 controls the switch circuit 104 to be turned on, causing the temperature of the heater 101 to rise, the amount of the energy supplied to the heater 101 determines a temperature rising rate of the heater 101. That is, when the energy supplied to the heater 101 is relatively large, in this stage, each wave has a relatively small cycle and a relatively large frequency, so that the temperature fluctuation frequency is relatively small. When the energy supplied to the heater 101 is relatively small, in this stage, each wave has a relatively large cycle and a relatively small frequency, so that the temperature fluctuation frequency relatively large.

At an initial moment t2, the turn-on time of the switch circuit 104 may be controlled to be a preset reference time, and the preset reference time is in a range of 1 s and 20 s, for example, 18 s, 15 s, 10 s, 8 s, or 6 s. In the subsequent time stages, the turn-on time may be gradually increased or decreased based on the preset reference time. As shown in FIG. 5, the turn-on time is gradually increased or decreased by A 0, with a value in a range of 1 s to 10 s.

It may be learned from the above that, at the time stage from t2 to t3, the temperature fluctuation frequency ω progressively increases with time in stages, that is, the energy supplied to the heater 101 progressively increases. In this way, even if the aerosol-forming substrate is exhausted in a later stage, an aerosol with consistent characteristics can be generated in this stage, thereby improving inhalation experience of a user.

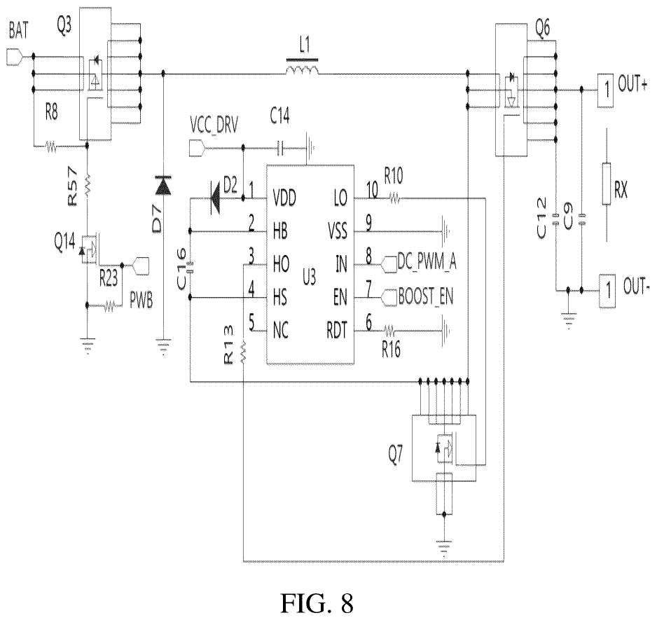

Referring to FIG. 7 and FIG. 8, different from the example in FIG. 1 and FIG. 2, in another example, a heater 1001 of the aerosol-generating apparatus 100 is configured as a peripheral or circumferential heating structure (the heater 1001 surrounds at least a part of the aerosol-forming substrate), and a heating manner is not limited. A controller 102 and a battery cell 103 in the aerosol-generating apparatus 100 are similar to the above.

The aerosol-generating apparatus 100 further includes a voltage regulation circuit 1004 coupled between the heater 1001 and the battery cell 103. The voltage regulation circuit 1004 includes a boost circuit and/or a buck circuit, for example, a BUCK-BOOST conversion circuit shown in FIG. 8. It should be noted that, the voltage regulation circuit 1004 is not limited to the BUCK-BOOST conversion circuit, and for example, may be at least one of a BOOST conversion circuit, a BUCK conversion circuit, a CUK conversion circuit, a ZETA conversion circuit, and a SEPIC conversion circuit.

In the time stage from t2 to t3 shown in FIG. 3, the controller 102 may control the voltage regulation circuit 1004, to control power to be supplied to the heater 1001, so that the temperature fluctuation frequency remains substantially constant or changes with time in stages.

It should be noted that, the specification of this application and the accompanying drawings thereof provide preferred embodiments of this application. However, this application may be implemented in various different forms, and is not limited to the embodiments described in this specification. These embodiments are not used as an additional limitation on the content of this application, and are described for providing a more thorough and comprehensive understanding of the content disclosed in this application. Moreover, various embodiments not listed above formed by further combining the foregoing technical features with each other are all construed as falling within the scope of this application. Further, for a person of ordinary skill in the art, improvements or modifications may be made according to the above descriptions, and all these improvements and modifications shall fall within the protection scope of the appended claims of this application.

1. A control method for an aerosol-generating apparatus, wherein the aerosol-generating apparatus comprises a heater configured to heat an aerosol-forming substrate to generate an aerosol and a power source that provides energy to the heater; wherein the method comprises:
controlling the energy supplied by the power source to the heater, so that a temperature of the heater fluctuates between a first temperature and a second temperature within a desired temperature range within a preset duration, the first temperature being greater than the second temperature;
wherein a temperature fluctuation frequency or cycle of the heater is substantially constant or varied within the preset duration.

2. The method according to claim 1, wherein the temperature fluctuation frequency of the heater gradually changes with time in stages.

3. The method according to claim 1, wherein the temperature fluctuation frequency of the heater progressively increases or progressively decreases with time in stages.

4. The method according to claim 1, wherein the preset duration comprises a plurality of time stages, and the temperature fluctuation frequency of the heater is maintained substantially constant in each of the time stages.

5. The method according to claim 1, wherein the preset duration comprises a first time stage and a second time stage, and a frequency at which the temperature of the heater fluctuates in the second time stage is greater than a frequency at which the temperature of the heater fluctuates in the first time stage.

6. The method according to claim 1, wherein the preset duration includes a plurality of time stages, and a duration of each of the time stages is different.

7. The method according to claim 1, wherein the preset duration comprises at least two time stages with a same duration.

8. The method according to claim 2, wherein when no change indication is obtained, the temperature fluctuation frequency of the heater is controlled according to a preset temperature fluctuation frequency and a duration corresponding to the preset temperature fluctuation frequency.

9. The method according to claim 2, wherein the temperature fluctuation frequency of the heater is changed when a change indication is obtained.

10. The method according to claim 9, wherein the change indication is based on detection of user inhalation.

11. The method according to claim 1, wherein the temperature fluctuation frequency of the heater is determined jointly by an amount of energy supplied to the heater and a temperature drop capability of the heater when no energy is provided.

12. The method according to claim 1, wherein the aerosol-generating apparatus further comprises a voltage regulation circuit; and
the method further comprises:
controlling the voltage regulation circuit to control energy supplied by the power source to the heater.

13. The method according to claim 1, wherein the aerosol-generating apparatus further comprises a switch circuit; and
the method further comprises:
controlling a turn-on time of the switch circuit to control a supply time of energy supplied by the power source to the heater.

14. The method according to claim 1, wherein the temperature fluctuation frequency is selected from values in a range of 0.05 Hz to 1 Hz.

15. The method according to claim 1, wherein the temperature fluctuation frequency changes within the preset duration, and a change amplitude is in a range of 0.1 Hz to 1 Hz.

16. The method according to claim 1, wherein an initial moment of the preset duration is a moment at which the temperature of the heater reaches a preset temperature or is an end moment when the heater remains at the preset temperature for a period of time; and a terminal moment of the preset duration is an inhalation end moment.

17. The method according to claim 1, wherein a difference between the first temperature and the second temperature within the desired temperature range is in a range of 2° C. to 10° C.

18. The method according to claim 1, further comprising: intermittently detecting a real-time temperature of the heater and controlling the temperature fluctuation of the heater according to the real-time temperature of the heater.

19. An aerosol-generating apparatus, comprising:
a heater, configured to heat an aerosol-forming substrate to generate an aerosol;
a power source, configured to supply energy to the heater; and
a controller, configured to control the energy supplied by the power source to the heater, so that a temperature of the heater fluctuates between a first temperature and a second temperature within a desired temperature range within a preset duration, the first temperature being greater than the second temperature; wherein a temperature fluctuation frequency or cycle of the heater is substantially constant or varied within the preset duration.

20. The aerosol-generating apparatus according to claim 19, wherein the preset duration comprises a first time stage and a second time stage, and a desired temperature range of the first time stage is different from a desired temperature range of the second time stage.
